(19) United States
(12) Patent Application Publication
(10) Pub. No.: US 2026/0153205 A1
(43) Pub. Date: Jun. 4, 2026

(54) LAMP FOR VEHICLE

(71) Applicant: HYUNDAI MOBIS CO., LTD., Seoul (KR)

(72) Inventors: Hyun Soo LEE, Yongin-si (KR); Na Ram JUN, Yongin-si (KR); Tae Yang PARK, Yongin-si (KR)

(73) Assignee: HYUNDAI MOBIS CO., LTD., Seoul (KR)

(21) Appl. No.: 19/290,715

(22) Filed: Aug. 5, 2025

(30) Foreign Application Priority Data
Dec. 4, 2024 (KR) 10-2024-0178620

(51) Int. Cl. F21S 41/24; F21S 43/241; F21S 43/249; F21W 102/135; F21W 103/55

(52) U.S. Cl. CPC F21S 41/24; F21S 43/241; F21S 43/249; F21W 2102/135; F21W 2103/55

(57) ABSTRACT

A lamp for a vehicle and a system therefor are provided. The lamp includes a light source, and a light guide part. The light guide part includes a front surface portion, a rear surface portion, an upper surface portion to connect the front surface portion and the rear surface portion, and a lower surface portion to connect the front surface portion and the rear surface portion. The light source includes a first light source disposed rearward of the light guide part and provided to face the rear surface portion, and a second light source provided below the first light source and spaced apart downward from the rear surface portion. The lower surface portion including a flange region having a portion protruding downward, the flange region partially provided forward of the second light source. A portion of the flange region that faces the second light source includes a concave-convex section.

### CROSS-REFERENCE TO RELATED APPLICATION

This application claims priority to and the benefit under 35 USC § 119(a) of Korean Patent Application No. 10-2024-0178620 filed in the Korean Intellectual Property Office on Dec. 4, 2024, the entire contents of which are incorporated herein by reference for all purposes.

### BACKGROUND

### 1. Field

The present disclosure relates to a lamp for a vehicle, and more particularly, to a lamp for a vehicle, the lamp being capable of forming a plurality of light distribution patterns.

### 2. Description of the Related Art

Various types of vehicle lamps, which are classified depending on functions thereof, are mounted in a vehicle. For example, low beam lamps, high beam lamps, daytime running light (DRL) lamps, and the like are mounted on a front side of the vehicle.

In the related art, because various types of lamps are mounted together in vehicles, light-emitting surfaces formed by the lamps are different from one another, which causes a problem in that designs of the vehicles cannot meet consumer demands when the lamps are turned on. Furthermore, because various types of lamps are mounted in vehicles, which causes a problem in that spaces occupied by the lamps in the vehicles are excessively large.

### SUMMARY

The present disclosure has been made in an effort to provide a lamp module for a vehicle, the lamp module having a structure in which one lamp for a vehicle may perform two or more functions, such that one light-emitting surface may be shared even in case that the lamps with different functions are turned on, thereby promoting differentiation in terms of designs of vehicles.

In order to achieve the above-mentioned object, one aspect of the present disclosure provides a lamp for a vehicle, the lamp including: a light source; and a light guide part provided at one side of the light source and configured to receive light emitted from the light source, in which the light guide part includes: a front surface portion configured to define a front region of the light guide part; a rear surface portion configured to define a rear region of the light guide part; an upper surface portion configured to connect the front surface portion and the rear surface portion and configured to define an upper region of the light guide part; and a lower surface portion configured to connect the front surface portion and the rear surface portion and configured to define a lower region of the light guide part, in which the light source includes: a first light source disposed rearward of the light guide part and provided to face the rear surface portion; and a second light source provided below the first light source and spaced apart downward from the rear surface portion, in which the lower surface portion includes a flange region including a portion protruding downward, the flange region partially provided forward of the second light source, and in which a portion of the flange region that faces the second light source includes a concave-convex section.

The entire light guide part may be formed integrally.

The concave-convex section may be provided as a plurality of concave-convex sections provided in an upward/downward direction (H).

The concave-convex section may include: a first concave-convex surface protruding rearward; and a second concave-convex surface disposed below the first concave-convex surface, connected to a rear end of the first concave-convex surface, and extending forward from the rear end of the first concave-convex surface, and the second concave-convex surface may include an inclined surface shape raised upward and rearward.

An angle (α) defined between the first concave-convex surface and the upward/downward direction (H) and an angle (β) defined between the second concave-convex surface and the upward/downward direction (H) may be different from each other.

The plurality of concave-convex sections may be provided such that the angles (β) defined between the second concave-convex surfaces in the concave-convex sections and the upward/downward direction (H) increase as the concave-convex sections are positioned downward.

The first concave-convex surfaces in the plurality of concave-convex sections may each be formed in parallel with a horizontal direction.

The first concave-convex surfaces of at least some of the plurality of concave-convex sections may include inclined surface shapes raised upward and rearward.

The lower surface portion may further include: a light guide protruding region spaced apart forward from the flange region and protruding downward; and a lower reflection region provided between the flange region and the light guide protruding region.

A horizontal cross-section of a rear surface of the light guide protruding region may include a portion having a shape convex rearward.

The lower reflection region may have a stepped section formed at a boundary between one side surface based on a leftward/rightward direction (W) and the other side surface based on the leftward/rightward direction (W).

The light guide part may further include a light collection region formed between the upper surface portion and the lower surface portion and provided to face the first light source.

The light collection region may include a portion having a collimator shape.

Light, which is emitted from the first light source and totally reflected by an inner surface of an upper portion of the light collection region, may reach the lower reflection region.

The lamp may further include: a holder member fixedly coupled to one side of the flange region.

The flange region may include: a first flange protruding section protruding in a leftward/rightward direction (W) from a remaining region excluding the flange region of the light guide part; and a second flange protruding section protruding upward from the remaining region excluding the flange region of the light guide part.

The first flange protruding section and the second flange protruding section may be connected directly to each other.

In another general aspect of the disclosure, a lamp system includes: a light guide part including a front surface portion, a rear surface portion, an upper surface portion connected to the front surface portion and the rear surface portion, and a lower surface portion connected to the front surface portion and the rear surface portion; a first light source disposed rearward of the light guide part and facing the rear surface portion; a second light source disposed below the first light source and spaced apart downward from the rear surface portion; and a controller configured to control the first light source and the second light source to form one or more light distribution patterns via the light guide part, wherein the lower surface portion includes a flange region including a portion protruding downward, the flange region disposed partially forward of the second light source, wherein a portion of the flange region that faces the second light source includes a concave-convex section, and wherein light emitted from the first light source is directed toward a first surface of the front surface portion, and light emitted from the second light source is directed through the concave-convex section and toward a second surface of the front surface portion.

The lower surface portion may include a light guide protruding region spaced apart forward from the flange region and protruding downward, and a lower reflection region provided between the flange region and the light guide protruding region, wherein the lower reflection region may include a stepped section formed at a boundary between one side surface based on a leftward/rightward direction (W) and the other side surface based on the leftward/rightward direction (W).

According to the present disclosure, one lamp for a vehicle may perform two or more functions, such that one light-emitting surface may be shared even in case that the lamps with different functions are turned on, thereby promoting differentiation in terms of designs of the vehicles.

### BRIEF DESCRIPTION OF THE DRAWINGS

FIG. 1 is a perspective view of a lamp for a vehicle according to the present disclosure.

FIG. 2 is a side view of the lamp for a vehicle according to the present disclosure.

FIG. 3 is an enlarged view illustrating a flange region of the lamp for a vehicle according to the present disclosure and the surroundings of the flange region.

FIG. 4 is a view illustrating a cross-sectional structure of a stepped section formed on a light guide part of the lamp for a vehicle according to the present disclosure.

### DETAILED DESCRIPTION

Hereinafter, a lamp for a vehicle according to the present disclosure will be described with reference to the drawings.

A lamp for a vehicle (hereinafter, referred to as a ‘lamp’) according to the present disclosure may be a lamp module capable of forming two or more types of light distribution patterns. That is, the lamp according to the present disclosure may individually form a first light distribution pattern and a second light distribution pattern different from the first light distribution pattern. For example, the first light distribution pattern may be a low beam pattern, and the second light distribution pattern may be a daytime running light (DRL) pattern. However, the types of the first and second light distribution patterns are not limited to the above-mentioned contents. Various types of beam patterns may be applied.

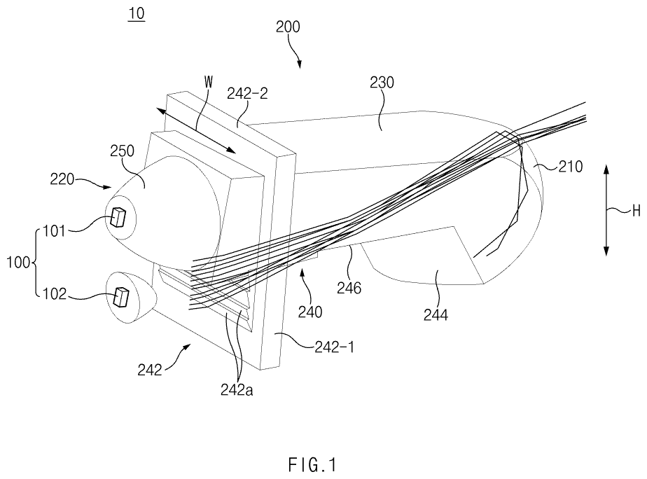

With reference to FIGS. 1 to 3, a lamp 10 according to the present disclosure may include a light source 100, and a light guide part 200 provided at one side of the light source 100 and configured to receive light emitted from the light source 100. The entire light guide part 200 according to the present disclosure may be a lens formed integrally. Therefore, according to the present disclosure, first and second light distribution patterns may be formed by one integrated lens, i.e., the light guide part 200. Even in case that the light distribution patterns with different functions are formed, one light-emitting surface may be shared by means of one light guide part, thereby promoting differentiation in terms of designs of the vehicles.

Meanwhile, a surface of the light guide part 200 may be divided into a plurality of regions depending on positions. More specifically, the light guide part 200 may include a front surface portion 210 configured to define a front region of the light guide part 200, a rear surface portion 220 configured to define a rear region of the light guide part 200, an upper surface portion 230 configured to connect the front surface portion 210 and the rear surface portion 220 and configured to define an upper region of the light guide part 200, and a lower surface portion 240 configured to connect the front surface portion 210 and the rear surface portion 220 and configured to define a lower region of the light guide part 200.

In addition, the light source 100 may include a first light source 101 disposed rearward of the light guide part 200 and provided to face the rear surface portion 220, and a second light source 102 provided below the first light source 101 and spaced apart downward from the rear surface portion 220. For example, the first light source 101 and the second light source 102 may each be an LED. According to the present disclosure, light emitted from the first light source 101 may form the first light distribution pattern (e.g., a low beam distribution pattern), and light emitted from the second light source 102 may form the second light distribution pattern (e.g., a DRL distribution pattern). A controller (not shown) may control the first light source 101 and the second light source 102 to form one or more light distribution patterns via the light guide part 200.

That is, according to the present disclosure, at least a part of the light emitted from the first light source 101 may pass through the rear surface portion 220 of the light guide part 200 and then exit to the outside, thereby forming the first light distribution pattern. At least a part of the light emitted from the second light source 102 may pass through the lower surface portion 240 of the light guide part 200 and then exit to the outside, thereby forming the second light distribution pattern. More particularly, the second light distribution pattern may be formed above the first light distribution pattern. Hereinafter, the features of the light guide part 200 for exhibiting the above-mentioned functions will be described in detail.

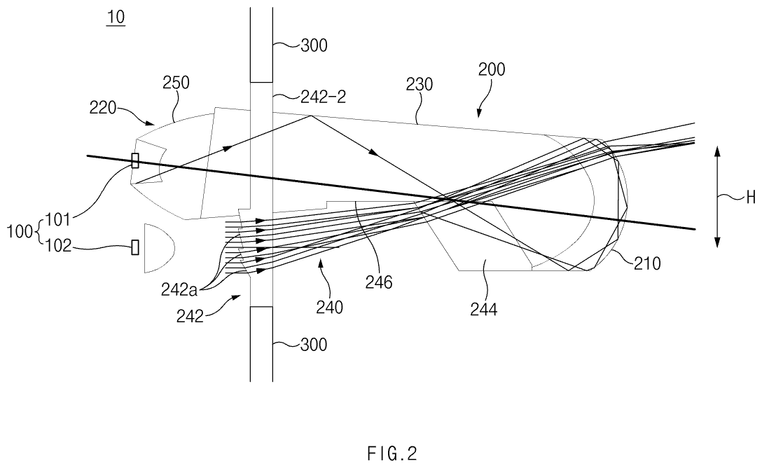

As illustrated in FIGS. 1 and 2, the lower surface portion 240 may include a flange region 242 including a portion protruding downward from another portion of the lower surface portion 240, the flange region 242 being at least partially provided forward of the second light source 102. Therefore, the light emitted from the second light source 102 may exit to the outside via the flange region 242. In this case, according to the present disclosure, a concave-convex section 242a having a concave-convex shape may be formed in a portion of the flange region 242 that faces the second light source 102.

According to the present disclosure, the light emitted from the second light source 102 may be refracted upward while passing through the concave-convex section 242a. Therefore, in case that the second light distribution pattern is the DRL distribution pattern as described above, the second light distribution pattern formed by the light emitted from the second light source 102 may be formed above the first light distribution pattern formed by the light emitted from the first light source 101. Hereinafter, the feature of the concave-convex section 242a will be described in detail.

As illustrated in FIGS. 1 to 3, the concave-convex section 242a may be provided as a plurality of concave-convex sections 242a disposed in an upward/downward direction H.

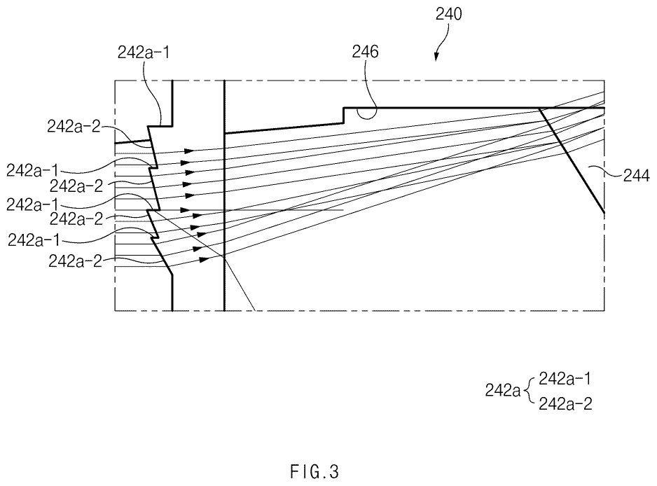

Meanwhile, the concave-convex section 242a may include a plurality of surfaces. More specifically, the concave-convex section 242a may include a first concave-convex surface 242a-1 protruding rearward, and a second concave-convex surface 242a-2 provided below the first concave-convex surface 242a-1, connected to a rear end of the first concave-convex surface 242a-1, and extending forward from the rear end of the first concave-convex surface 242a-1. In one concave-convex section 242a, the second concave-convex surface 242a-2 may be positioned below the first concave-convex surface 242a-1. Among the concave-convex sections 242a adjacent to one another in the upward/downward direction H, the second concave-convex surface 242a-2 provided in the concave-convex section 242a positioned at the upper side may be connected to the first concave-convex surface 242a-1 provided in the concave-convex section 242a positioned at the lower side. For example, the first concave-convex surface 242a-1 and the second concave-convex surface 242a-2 may each have a flat shape. More particularly, as illustrated in FIG. 3 and the like, the second concave-convex surface 242a-2 may include an inclined surface shape raised upward and rearward (i.e., a direction toward the second light source) or be provided as an inclined surface raised upward and rearward.

Meanwhile, according to the present disclosure, the concave-convex section 242a may have an asymmetric shape with respect to a forward/rearward direction. More specifically, as illustrated in FIG. 3, an angle α defined between the first concave-convex surface 242a-1 and the upward/downward direction H and an angle β defined between the second concave-convex surface 242a-2 and the upward/downward direction H may be different from each other.

In addition, more particularly, the plurality of concave-convex sections 242a may be provided such that the angles β defined between the second concave-convex surfaces 242a-2 in the concave-convex sections 242a and the upward/downward direction H increase as the concave-convex sections 242a are positioned downward. It may be understood that the second concave-convex surfaces 242a-2 have inclined shapes that become closer to a horizontal direction as the second concave-convex surfaces 242a-2 are positioned downward. In this case, there is an advantage in that the light emitted from the second light source 102 may be more concentrated when the light emitted from the second light source 102 is refracted while passing through the concave-convex section 242a and then reaches the front surface portion 210.

Meanwhile, according to the present disclosure, when the light emitted from the second light source 102 is refracted upward while passing through the concave-convex section 242a, the light may be refracted by the second concave-convex surface 242a-2 of the concave-convex section 242a instead of the first concave-convex surface 242a-1. Therefore, the most part of the light emitted from the second light source 102 may pass through the second concave-convex surface 242a-2 between the first concave-convex surface 242a-1 and the second concave-convex surface 242a-2.

In order to achieve the above-mentioned purpose, the first concave-convex surfaces 242a-1 in the plurality of concave-convex sections 242a may each be formed in parallel with the horizontal direction. Alternatively, the first concave-convex surfaces 242a-1 of at least some of the plurality of concave-convex sections 242a may include inclined surface shapes raised upward and rearward. It may be understood that the first concave-convex surface 242a-1 is covered by the second concave-convex surface 242a-2 when the concave-convex section 242a is viewed from the rear side.

With continued reference to FIGS. 1 and 2, the lower surface portion 240 may further include a light guide protruding region 244 spaced apart forward from the flange region 242 and protruding downward, and a lower reflection region 246 provided between the flange region 242 and the light guide protruding region 244.

The light guide protruding region 244 may be configured such that the light emitted from the second light source 102 and exiting from the flange region 242 enters the light guide protruding region 244 again. The light entering the light guide protruding region 244 may move upward, pass through the front surface portion 210 of the light guide part 200, and then finally exit from the light guide part 200, such that the second light distribution pattern may be formed. Meanwhile, the lower reflection region 246 may be configured to be involved in forming the first light distribution pattern. That is, the light emitted from the first light source 101 may be reflected by the lower reflection region 246 and then move upward and forward. Thereafter, the light may pass through the front surface portion 210 of the light guide part 200 and finally exit from the light guide part 200, such that the second light distribution pattern may be formed.

For example, a horizontal cross-section of a rear surface of the light guide protruding region 244 may include a portion having a shape convex rearward. This is to maximize luminous efficiency by collecting the light emitted from the second light source 102. More particularly, the horizontal cross-section of the entire rear surface of the light guide protruding region 244 may have a shape convex rearward.

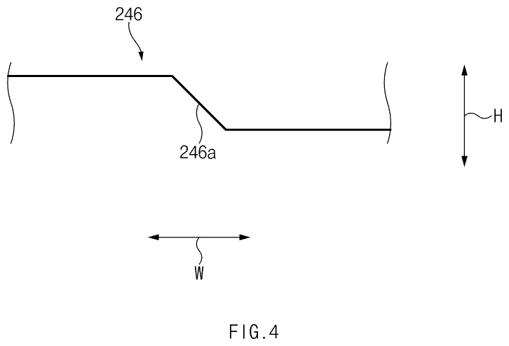

Meanwhile, as described above, the first light distribution pattern may be the low beam distribution pattern. That is, the light emitted from the first light source 101 may form the low beam distribution pattern. In this case, as illustrated in FIG. 4, the lower reflection region 246 may have a stepped section 246a formed at a boundary between one side surface based on a leftward/rightward direction W and the other side surface based on the leftward/rightward direction W. Based on the boundary of the stepped section 246a, one side surface of the lower reflection region 246 based on the leftward/rightward direction W and the other side surface of the lower reflection region 246 based on the leftward/rightward direction W may be different in height in the upward/downward direction H from each other. The above-mentioned stepped section 246a may have a shape corresponding to a cut-off line defined at an upper boundary of the low beam distribution pattern.

In addition, the light guide part 200 may further include a light collection region 250 formed between the upper surface portion 230 and the lower surface portion 240 and provided to face the first light source 101. For example, an outer surface of the light collection region 250 may have a curved shape as a whole. More particularly, the light collection region 250 may include a portion having a collimator shape or have a collimator shape.

According to the present disclosure, the light, which is emitted from the first light source 101 and totally reflected by an inner surface of an upper portion of the light collection region 250, may reach the lower reflection region 246, and the light reflected by the lower reflection region 246 may move upward and forward and then exit to the outside through the front surface portion 210 of the light guide part 200.

Meanwhile, as illustrated in FIGS. 1 and 2, the lamp 10 according to the present disclosure may further include a holder member 300 fixedly coupled to one side of the flange region 242. That is, according to the present disclosure, the flange region 242 may be configured to not only contribute to forming the second light distribution pattern but also be involved in being fixedly coupled to the holder member 300.

For example, the flange region 242 may include a first flange protruding section 242-1 protruding in the leftward/rightward direction W from a remaining region excluding the flange region 242 of the light guide part 200, and a second flange protruding section 242-2 protruding upward from the remaining region excluding the flange region 242 of the light guide part 200. The first flange protruding section 242-1 and the second flange protruding section 242-2 may each be fixedly coupled to the holder member 300. For example, the first flange protruding section 242-1 and the second flange protruding section 242-2 may be connected directly to each other. It may be understood that an upper region, a lower region, and lateral regions in the leftward/rightward direction of the flange region 242 each have a shape protruding from the region excluding the first and second flange protruding sections 242-1 and 242-2 of the light guide part 200 when the light guide part 200 is viewed from the rear or front side.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A lamp for a vehicle, the lamp comprising:
a light source; and
a light guide part provided at one side of the light source and configured to receive light emitted from the light source,
wherein the light guide part comprises:
a front surface portion configured to define a front region of the light guide part;
a rear surface portion configured to define a rear region of the light guide part;
an upper surface portion configured to connect the front surface portion and the rear surface portion and configured to define an upper region of the light guide part; and
a lower surface portion configured to connect the front surface portion and the rear surface portion and configured to define a lower region of the light guide part,
wherein the light source comprises:
a first light source disposed rearward of the light guide part and provided to face the rear surface portion; and
a second light source provided below the first light source and spaced apart downward from the rear surface portion,
wherein the lower surface portion comprises a flange region comprising a portion protruding downward, the flange region partially provided forward of the second light source, and
wherein a portion of the flange region that faces the second light source comprises a concave-convex section having a concave-convex shape.

2. The lamp of claim 1, wherein the entire light guide part is formed integrally.

3. The lamp of claim 1, wherein the concave-convex section comprises a plurality of concave-convex sections provided in an upward/downward direction (H).

4. The lamp of claim 3, wherein the concave-convex section comprises:
a first concave-convex surface protruding rearward; and
a second concave-convex surface disposed below the first concave-convex surface, connected to a rear end of the first concave-convex surface, and extending forward from the rear end of the first concave-convex surface, and
wherein the second concave-convex surface comprises an inclined surface shape raised upward and rearward.

5. The lamp of claim 4, wherein an angle α defined between the first concave-convex surface and the upward/downward direction (H) and an angle (β) defined between the second concave-convex surface and the upward/downward direction (H) are different from each other.

6. The lamp of claim 5, wherein the plurality of concave-convex sections are provided such that the angles (β) defined between the second concave-convex surfaces in the concave-convex sections and the upward/downward direction (H) increase as the concave-convex sections are positioned downward.

7. The lamp of claim 4, wherein the first concave-convex surfaces in the plurality of concave-convex sections are each formed in parallel with a horizontal direction.

8. The lamp of claim 4, wherein the first concave-convex surfaces of at least some of the plurality of concave-convex sections comprise inclined surface shapes raised upward and rearward.

9. The lamp of claim 1, wherein the lower surface portion further comprises:
a light guide protruding region spaced apart forward from the flange region and protruding downward; and
a lower reflection region provided between the flange region and the light guide protruding region.

10. The lamp of claim 9, wherein a horizontal cross-section of a rear surface of the light guide protruding region comprises a portion having a shape convex rearward.

11. The lamp of claim 9, wherein the lower reflection region includes a stepped section formed at a boundary between one side surface based on a leftward/rightward direction (W) and the other side surface based on the leftward/rightward direction (W).

12. The lamp of claim 9, wherein the light guide part further comprises a light collection region formed between the upper surface portion and the lower surface portion and provided to face the first light source.

13. The lamp of claim 12, wherein the light collection region comprises a portion having a collimator shape.

14. The lamp of claim 12, wherein light, which is emitted from the first light source and totally reflected by an inner surface of an upper portion of the light collection region, reaches the lower reflection region.

15. The lamp of claim 1, further comprising:
a holder member fixedly coupled to one side of the flange region.

16. The lamp of claim 15, wherein the flange region comprises:
a first flange protruding section protruding in a leftward/rightward direction (W) from a remaining region excluding the flange region of the light guide part; and
a second flange protruding section protruding upward from the remaining region excluding the flange region of the light guide part.

17. The lamp of claim 16, wherein the first flange protruding section and the second flange protruding section are connected directly to each other.

18. A lamp system, the system comprising:
a light guide part comprising:
a front surface portion;
a rear surface portion;
an upper surface portion connected to the front surface portion and the rear surface portion; and
a lower surface portion connected to the front surface portion and the rear surface portion;
a first light source disposed rearward of the light guide part and facing the rear surface portion;
a second light source disposed below the first light source and spaced apart downward from the rear surface portion; and
a controller configured to control the first light source and the second light source to form one or more light distribution patterns via the light guide part,
wherein the lower surface portion comprises a flange region including a portion protruding downward, the flange region disposed partially forward of the second light source,
wherein a portion of the flange region that faces the second light source comprises a concave-convex section, and
wherein light emitted from the first light source is directed toward a first surface of the front surface portion, and light emitted from the second light source is directed through the concave-convex section and toward a second surface of the front surface portion.

19. The system of claim 18, wherein the lower surface portion comprises:
a light guide protruding region spaced apart forward from the flange region and protruding downward; and
a lower reflection region provided between the flange region and the light guide protruding region, and
wherein the lower reflection region includes a stepped section formed at a boundary between one side surface based on a leftward/rightward direction (W) and the other side surface based on the leftward/rightward direction (W).
